(19) United States
(12) Patent Application Publication
(10) Pub. No.: US 2005/0140715 A1
(43) Pub. Date: Jun. 30, 2005

(54) Screen printing machine having a replaceable ink jet printing unit

(76) Inventor: Harutiun Manoukian, Intimiano (IT)

Correspondence Address: NIXON & VANDERHYE, PC, 1100 N GLEBE ROAD, 8TH FLOOR, ARLINGTON, VA, 22201-4714, US

(21) Appl. No.: 10/516,624

(22) PCT Filed: Jun. 4, 2002
(86) PCT No.: PCT/IT02/00366

(51) Int. Cl. B41J 2/015

(52) U.S. Cl. 347/20

(57) ABSTRACT

There are disclosed a station (10) for applying substances to a substrate (1,50), a machine comprising at least one of these stations and a method for applying substances to a substrate. The individual station (10) is provided with at least one mobile printing bridge (11) on which it is possible to install and control either an assembly (20) for applying substances in screen printing mode or an assembly (30) for applying substances in digital mode.

### FIELD OF THE INVENTION

The present invention relates to a station for applying one or more substances to a substrate and a machine comprising at least one of these stations, and also a method for applying substances to a substrate.

In particular, the invention relates to the printing of images and application of substances to substrates of various types, such as fabrics, papers, plastics, glass and ceramic materials, metals, printed circuit boards and the like.

### BACKGROUND OF THE INVENTION

Various examples of printing machines which traditionally use the screen printing technique to print images with inks in one or more colours on substrates of various types, and to apply coating substances before and/or after application of the inks, have been known in the art for some time.

In general, machines for flat printing using the screen printing technique comprise a plurality of stations arranged along a common production line. Each of the printing stations is dedicated to the application of a particular substance, for example an ink of specific colour, a material to precoat the substrate, a coating material of the finished product or the like.

This type of prior art machines has various good points, especially from the point of view of the printing quality and productivity. Nonetheless, in some cases, these machines are somewhat unsuitable to be used to obtain the desired results effectively and inexpensively.

Firstly, screen printing machines are somewhat unsuitable to produce inexpensive production batches in small numbers. In fact, the preparation of the printing matrices (or screens) which must be installed in each station is still today a relatively lengthy and costly procedure, meaning that the preparation costs connected to a single production batch may be considerably high in the case in which production is limited to a few exemplars.

There are also frequent cases in which it is necessary to print products in which only a few sections of the images and/or information applied to the substrate vary, while most of the background sections remain unvaried in relation to previous batches.

A possible example is the printing of advertising posters, the general appearance of which may remain the same (for example, the typical colours and logos of a manufacturer and/or a commercial distributor) while certain specific information is varied (for example special offers, discounts and relative periods of validity).

Another example is the production of articles of clothing, some batches of which may have identical characteristics from the point of view of basic colours and their layout, but different information with regard to other indications present on these articles. For example, tee-shirts intended for sport activities (the same colours possibly with different sponsors), those distributed at special sport events (such as motor car and motorcycle racing) or recreational events (concerts, meetings, etc.).

In these cases, the use of a screen printing machine would require the production of different printing matrices and their replacement each time even only a few sections of the basic product need to be varied, thus involving costs which inevitably have a high incidence on the final product and which are even more unacceptable in the case of limited numbers.

In some cases, it may be possible to produce the basic product using the screen printing technique, and subsequently applying the other sections with machines using different techniques. This solution may often be impractical, for example when printing continuous reel-fed substrates, whether these are fabrics or papers. Nonetheless, where practicable, it is difficult or even impossible to obtain the precision required to guarantee a high quality final product.

An object of the present invention is to provide a station for applying one or more substances to a substrate which is particularly simple and inexpensive to adapt to various types of production and various types of substrate, while maintaining a high level of quality.

Another object of the present invention is to provide a machine for applying substances to a substrate which is particularly versatile to use in the production of articles even in limited batches, or also of articles in which only a few features vary in relation to a basic article.

A further object of the present invention is to propose a method for applying substances to a substrate which is particularly inexpensive in the production of articles even in limited batches, or also of articles in which only a few features vary in relation to a basic article.

### SUMMARY OF THE INVENTION

These objects are achieved by the present invention, which relates to a station for applying one or more substances to a substrate, of the type comprising at least one mobile printing bridge, characterised in that it comprises means for installing and means for controlling, on the mobile printing bridge, an assembly for applying substances using the screen printing mode or an assembly for applying substances using the digital mode.

The possibility of transforming a screen printing station into a digital printing station, or vice versa, allows maximum versatility of use to be attained for any type of production and for batches of any quantity.

A station of this type positioned in a common production line may be set as a screen printing station to apply standard substances on a basic article, such as a coating, a background colour or the like, while it may be set as a digital printing station in all cases in which the use of a similar type of application may be advantageous, for example in the case of small batches for printing images in one or more colours, or to complete with variable details a basic article printed prevalently with the screen printing mode.

The invention also relates to a machine for applying substances to a substrate, of the type comprising a plurality of application stations arranged along a common production line, at least one unit for general control of the machine and means to transfer the substrate from one of the stations to another subsequent station, characterised in that it comprises at least one station to apply one or more substances in which an assembly for applying substances using the screen printing mode or an assembly for applying substances using the digital printing mode can be installed without distinction.

The possibility of converting one or more stations from the screen printing application mode to the digital printing application mode, or vice versa, allows the user of a machine made in this manner to configure each station for adapting the machine to any type of production. If necessary, in the event that all stations are of the convertible type, the machine can be configured for printing performed entirely using the digital mode, or for printing performed entirely using the screen printing mode.

Each of the stations for digital application of substances to the substrate comprises one or more heads for ink-jet type printing. For example, each digital printing station may comprise at least one printing bridge, fixed or movable, on which even only one head may be fitted which moves alternatively along the full length of the printing bridge.

Alternatively, each printing bridge in each digital printing station may comprise several fixed heads, if necessary arranged in groups, distributed along the entire length of the bridge.

According to needs, the heads for ink-jet type printing in one or more digital printing stations may be fed with the same substance or ink, or each may be fed with substances or inks that differ from one another.

The invention also relates to a method for applying substances to a substrate, in which the substances are applied to the substrate in a plurality of stations arranged along a common production line, characterised in that each of the stations is set for application of one or more substances with the screen printing technique or with the digital printing technique.

The method according to the present invention may be used both with a substrate composed of a continuous sheet and with a substrate composed of separate sheets. The materials of which the substrate is formed may also be of various types, such as fabrics or media produced in any case with textile fibres, papers, plastic films, sheets or plates in rigid or flexible materials.

### BRIEF DESCRIPTION OF THE DRAWINGS

Further characteristics and advantages of the present invention shall become clearer from the following description with reference to the attached schematic drawings, in which:

FIG. 1 is a perspective view of a station for applying one or more substances according to a possible embodiment of the present invention, with an assembly installed for printing with the screen printing technique;

FIG. 2 shows the station of FIG. 1 during the removal of some typical elements of the assembly for printing in the screen printing mode;

FIG. 3 shows the station of FIG. 1 without any printing unit installed;

FIG. 4 shows the station of FIG. 1 during the phase to install a unit for printing in the digital mode;

FIG. 5 shows the station of FIG. 1 with a unit for printing in the digital mode installed;

FIG. 6 is a partial perspective view of a machine according to a possible embodiment of the present invention, with a pair of printing stations arranged for the application of substances using different techniques;

FIG. 7 is a perspective view of an assembly for digital printing according to a possible embodiment of the present invention;

FIGS. 8A and 8B show some variants in the operation of the digital printing stations that can be used in a machine according to the present invention; and

FIGS. 9A, 9B and 9C represent some practical examples of configuration of the printing stations in a machine according to the present invention.

### MODES FOR CARRYING OUT THE INVENTION

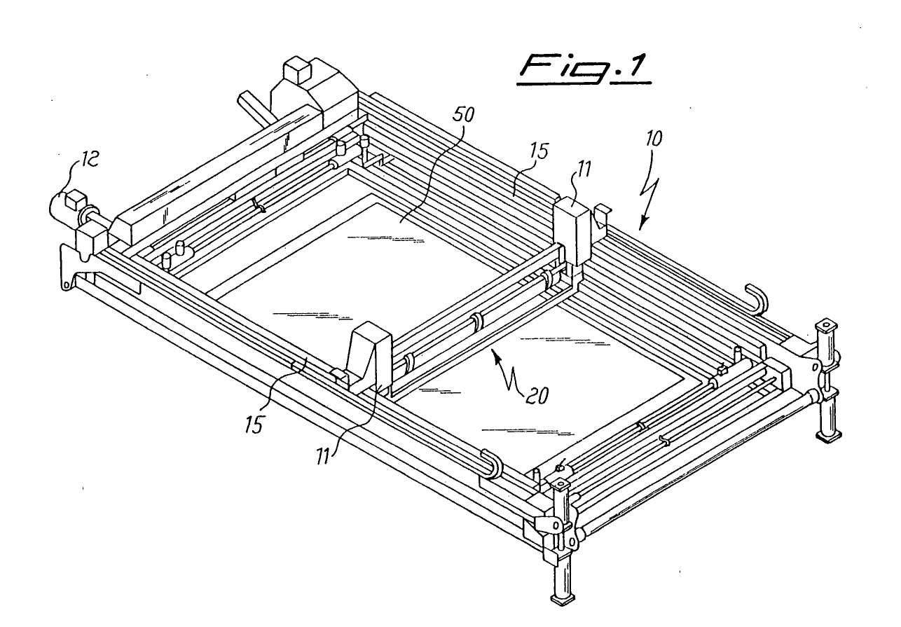

FIG. 1 represents a station 10 for applying one or more substances according to a possible embodiment of the present invention. In the view of FIG. 1, the station 10 is arranged for printing in the screen printing mode, that is equipped with an assembly 20 for screen printing mounted on supports 11 which are movable on a frame 15. Under the station 10, a substrate 50 is also visible, composed for example of a single sheet.

The mobile supports 11 are made to move by a motor 12 controlled by a local control device (not represented); this device also controls operation of the remaining mobile members of the station 10, for example raising and lowering the doctor/scraper unit in the assembly 20, movement of the printing matrix and other movements specific to the stations for screen printing and any other additional movements.

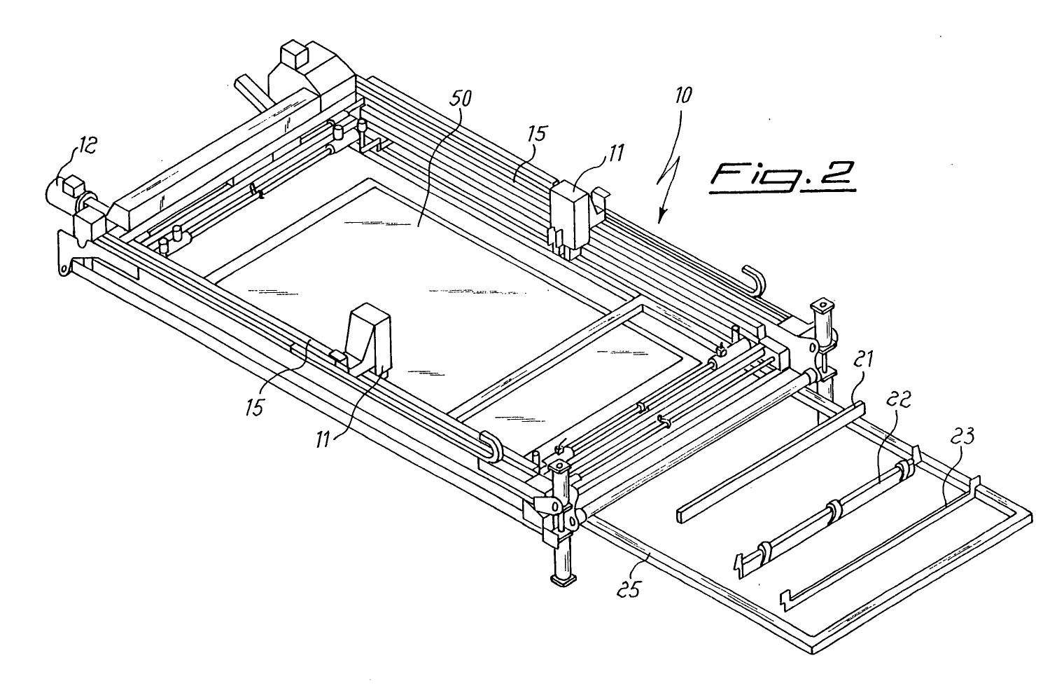

FIG. 2 shows the same printing station 10 during the removal of some typical elements of the assembly 20 for printing in the screen printing mode.

The frame 25 of the printing matrix is firstly removed from the station 10, while the supporting bar 21, the doctor 22 and the scraper 23 are removed from the mobile supports 11. After removing these elements, the station 10 is in the condition represented in FIG. 3.

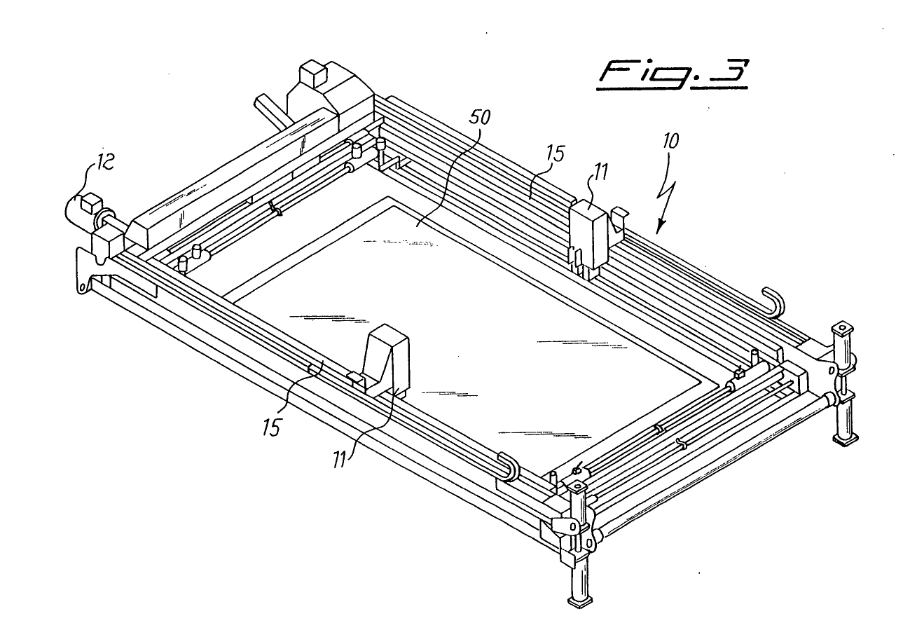

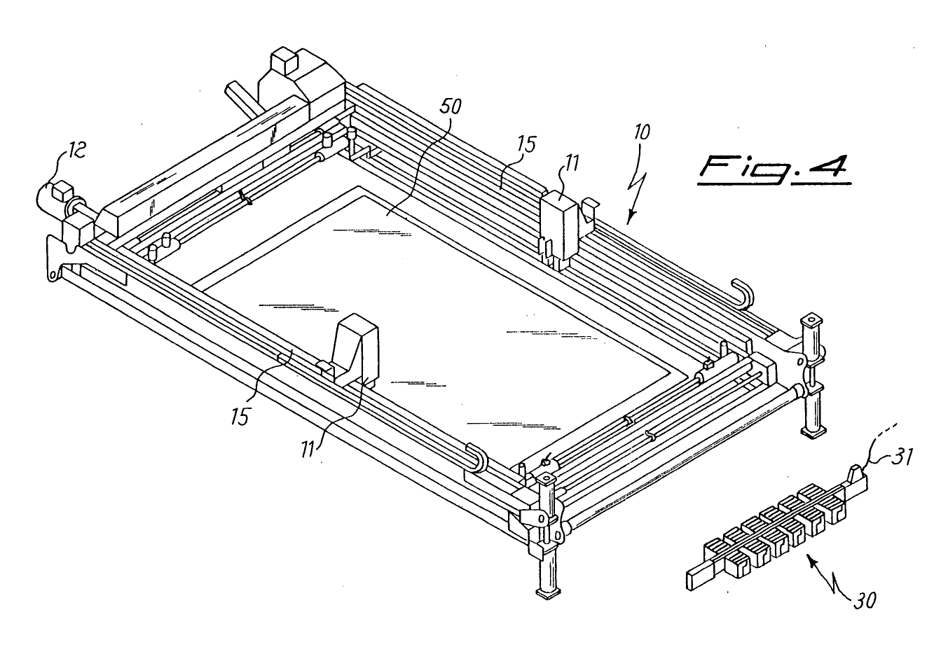

At this point, with reference to FIG. 4, an assembly 30 for digital printing may be installed on the mobile supports 11 of the station 10. The assembly 30 comprises a bundle of wires 31 which connect the printing heads of the assembly 30 for digital printing to the local control device associated with the station 10.

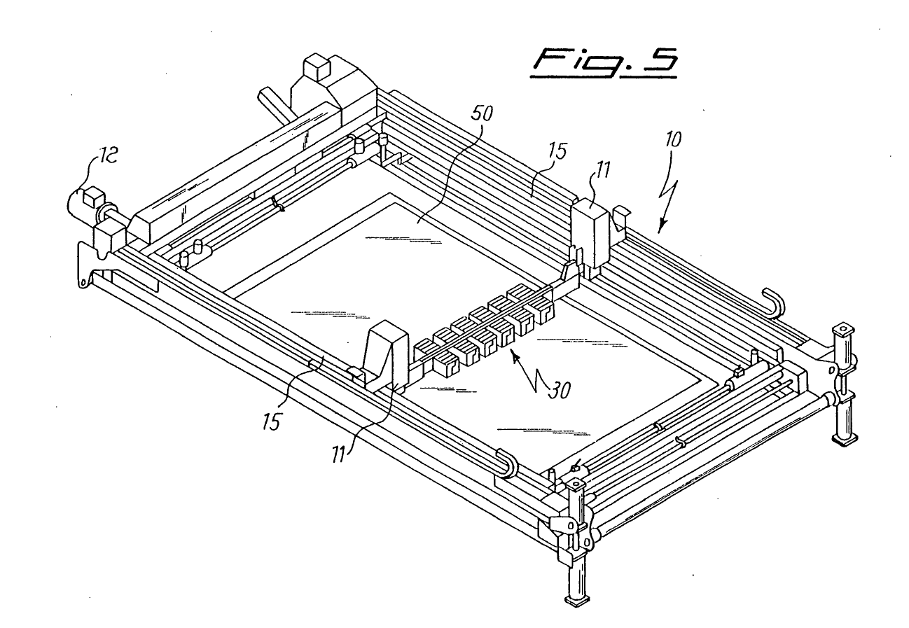

Upon completion of installation (FIG. 5), the assembly 30 is mounted on the mobile supports 11 and the local control device associated with the station 10 is set for operation in digital mode, for example to regulate movement of the printing bridge, now equipped with an assembly 30 for digital printing, to halt movement of the print matrix (no longer present in this case) and additional mobile members, and to control the printing heads associated with the assembly 30 for digital printing.

FIG. 6 is a schematic partial view of a machine according to the present invention for applying substances, such as inks, coatings or the like, to a substrate. In this view, the majority of the movement mechanisms and constructional details have been omitted for clarity.

The machine represented in FIG. 6 comprises a system for transferring a substrate composed of a conveyor belt 1 which moves in the direction represented by the arrow W. A substrate, for example a continuous sheet or separate sheets spaced from one another, is laid on the conveyor belt 1 and transferred from one application station to the other along a common production line.

Automatic progress of the conveyor belt 1, and therefore of the substrate deposited on it, is controlled by a general control system of the machine; this system also has the task of conversing with each control device associated with each printing and/or substance application station.

The partial view in FIG. 6 shows at least one application station 10S configured to apply a substance using the screen printing technique, and therefore equipped with an assembly 20 for screen printing, and a station 10D to apply one or more substances in digital mode, and therefore equipped with an assembly 30 for digital printing.

In this embodiment, both the assembly 20 of the station 10S and the assembly 30 of the station 10D move in the two opposite senses in the direction indicated by the double arrow B, that is in a direction substantially perpendicular to the direction of belt progress 1 and therefore of the substrate laid on the belt.

The assembly 20 for applying substances with the screen printing technique may comprise for example a doctor/doctor system, such as the one prevalently used in the field of printing on fabric, or a doctor/scraper system, such as the one used for printing other media in general (papers, plastics, etc.) or also a doctor with pressure inker.

The general control system of the machine, fitted both with stations 10S configured in screen printing mode and stations 10D configured in digital mode, must take account of the different production speeds of each station.

One possibility is, for example, to control each digital printing station 10S independently from the general control system of the machine, although in synchronism with this.

In other words, once the substrate has been positioned correctly under any one of the digital printing stations 10D, the control system of the machine sends a “print enable” signal to the local control device associated with this digital printing station 10D.

The printing station 10D performs a printing cycle while the control device associated with it sends and maintains a “busy” signal to the machine. At the end of the printing cycle, the control device of the station 10D ceases to send the “busy” signal and the general control system of the machine regains control of the machine. In the case in which several stations 10D are fitted on the same machine, the general system waits until all the stations 10D have finished their cycle before proceeding to transfer the substrate from any one of the stations to the next.

The fact that each printing station 10S or 10D has its own independent control device is prevalently determined by the different requirements of a printing station 10D configured for application with the digital technique compared with a printing station 10S configured for application with the screen printing technique. For example, unlike traditional screen printing stations 10S, in a digital printing station 10D it is necessary to provide the opportunity to perform head cleaning cycles, test cycles, preheating cycles or the like.

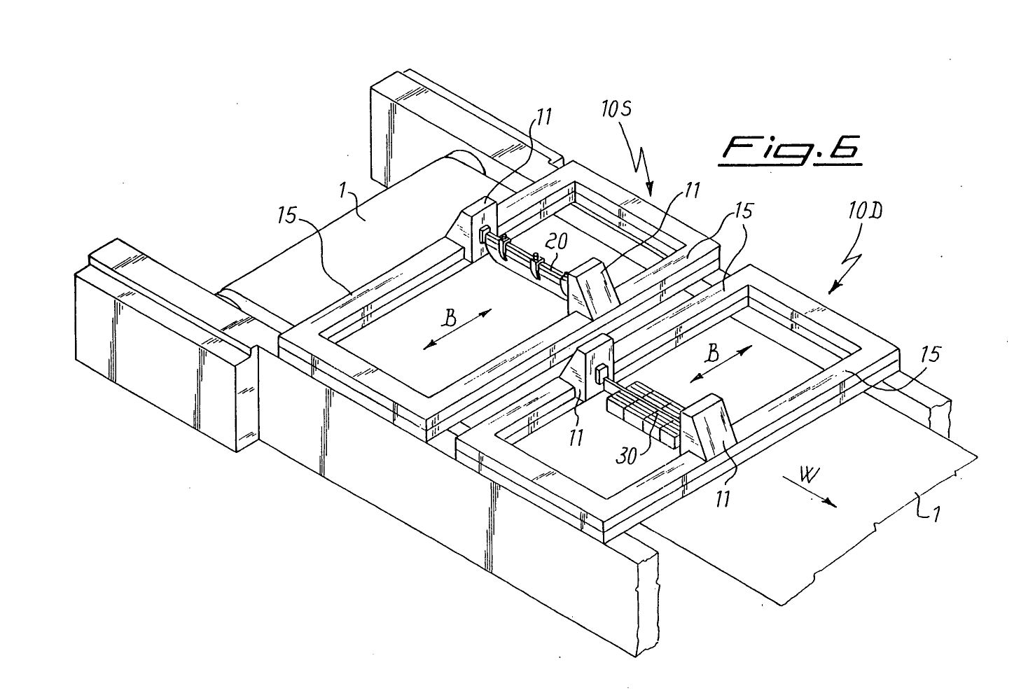

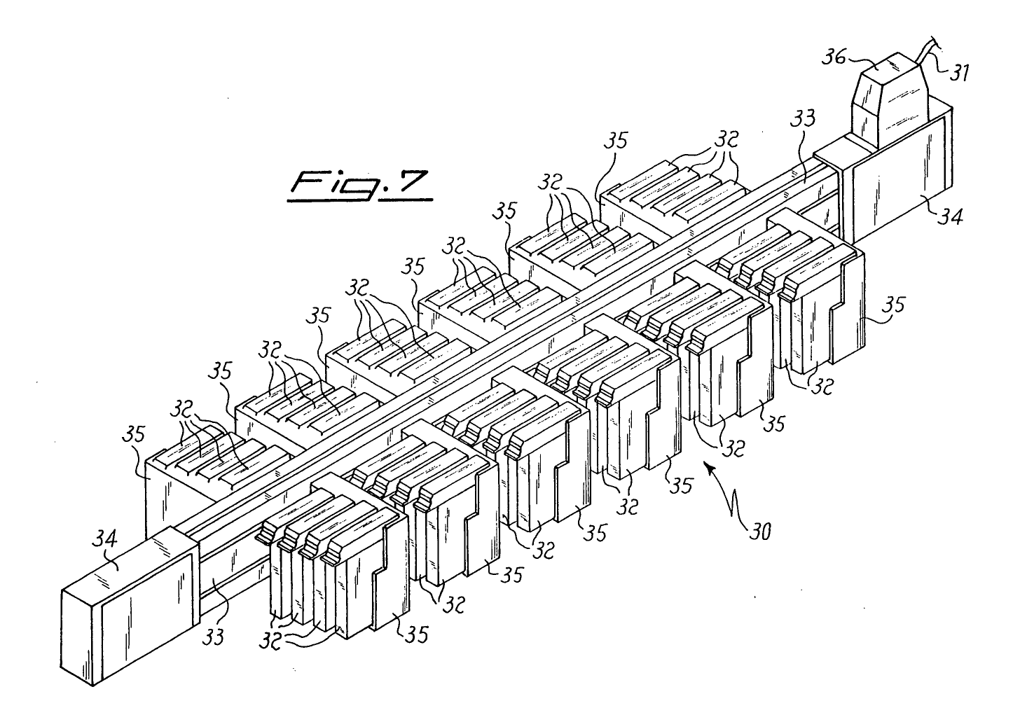

The view in FIG. 7 shows in greater detail a printing bridge 30 of a digital printing station 10D such as the one illustrated in FIG. 6.

The printing bridge 30 comprises in particular a plurality of housings 35, each capable of holding a certain number of heads 32 for ink jet type printing. The housings 35 are supported by a transverse bar 33 with ends 34 for fixing to the mobile supports 11 present in each station 10. Fitted at one of the ends 34, is a multipolar socket, attached to which is a connector 36, leading from which is the bundle of wires 31 connected to the local control device of the station 10.

The ink jet printing heads 32 present on each assembly 30 may be fed with a single type of substance, for example an ink of the same colour, or may be fed with various different substances, such as inks of four or more colours, or even fixing, coating or similar compounds. The number of heads 32 present on each printing bridge 30 may obviously differ from the number shown in FIG. 7 purely as an example.

The substances and inks may also be fed to the heads 32 by means of external supply tanks and flexible supply pipes (not shown) connected to the tank associated with each head.

FIGS. 8A and 8B schematically show the possible movements of a printing assembly 30 in a station 10D for digital printing or application of one or more substances.

In the diagram in FIG. 8A, the printing bridge 30 is movable in a direction substantially perpendicular (double arrow B) to the progress direction of the conveyor belt 1 (arrow W), similarly to what is shown in FIG. 6.

In the diagram in FIG. 8B, the printing assembly 30 is fixed in a first pre-established position during the printing operations and extends perpendicularly in relation to the progress direction of the belt 1. To allow the head cleaning operations, the printing assembly 30 can be moved to a second pre-established position (represented by the dashed line) before being returned to the printing position.

Figures from 9A to 9C represent some diagrams relative to the settings of the printing stations in the same machine for applying substances according to the present invention.

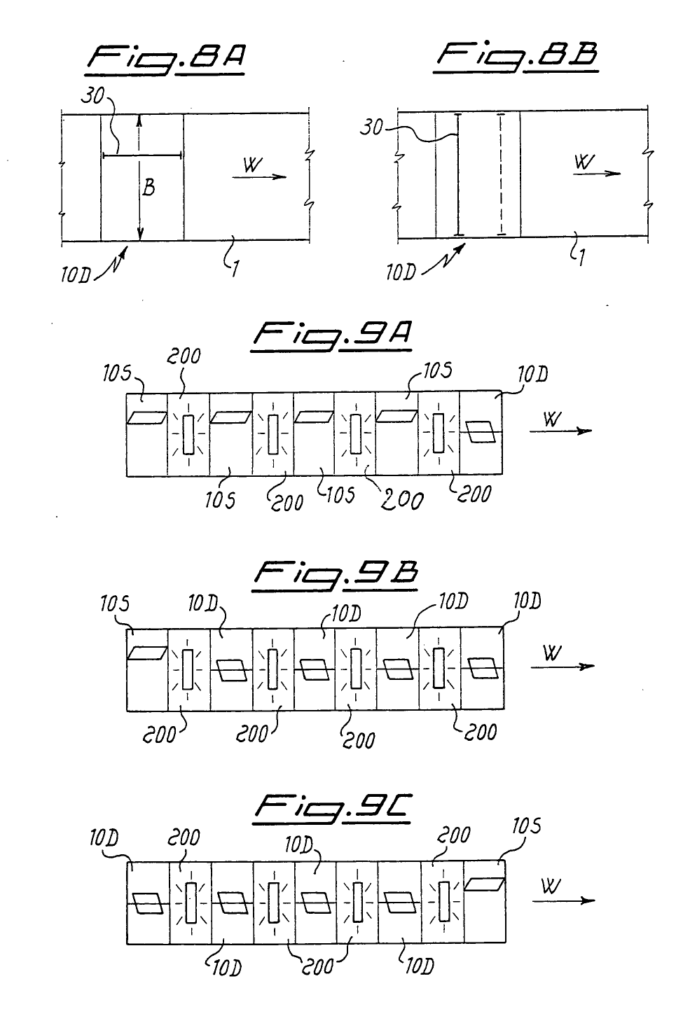

The machine in FIG. 9A, for example, has four stations 10S for printing with the four-colour screen printing technique and only one digital printing station 10D, positioned downstream in relation to the direction of movement W of the conveyor belt. The digital printing station 10D may be used to reproduce variable information using one or more colours. Between the various printing stations 10S and 10D drying stations 200 are usually provided, both of the ventilation and UV lamp type, controlled by the general control system of the machine. Operation of one or more of the drying stations 20 may be excluded in the case in which this is not indispensable between one application station and the next.

The diagram in FIG. 9B shows a first station 10S configured to apply a pre-treatment substance to a substrate, by means of the screen printing technique, followed by digital stations 10D for printing, for example, four-colour backgrounds and any variable information.

In the diagram in FIG. 9C four digital stations 10D are configured, each dedicated for example to printing a single colour to provide four-colour images, and a last station 10S configured to apply a protective transparent “varnish” with the screen printing mode.

Even if not expressly represented, all the printing stations are preferably equipped with devices for the registration of each printing station in relation to the substrate being conveyed under it. An example is the HAR (High Accuracy Registration) device already used by the Applicant in machines with screen printing stations only.

Various modifications may be made without departing from the scope of the present invention. For example, in the case in which the substrate is composed of separate sheets, the sheets can be transferred from one station to the next and positioned in the latter by known transfer means, for example equipped with mobile grippers capable of lifting a sheet from one station and transferring it to the next.

Moreover, although the examples shown here refer to flat printing, in addition to the convertible stations for flat printing according to the present invention, one or more stations for rotary type screen printing may also be provided.

1. A station for applying one or more substances to a substrate, of the type comprising at least one mobile printing bridge, characterised in that it comprises means to install and means to control, on said mobile printing bridge, an assembly for applying substances in screen printing mode or an assembly for applying substances in digital mode.

2. A station for applying one or more substances according to claim 1, wherein said means to install said assemblies for screen printing or digital application of one or more substances comprise at least one pair of supporting elements to mount on said mobile printing bridge at least one doctor/doctor unit or at least one doctor/scraper unit of an assembly for applying one or more substances in screen printing mode, and to mount at least a bar to support a plurality of heads for applying one or more substances in digital mode.

3. A station for applying one or more substances according to claim 1, wherein said means to alternatively control said assemblies for screen printing or digital application of one or more substances comprise a programmable control device to perform at least one of the following functions:
data exchange under the form of signals with at least one general control unit associated with a machine to apply substances in which said station is installed;—movement of said mobile printing bridge;
movement of one or more mobile parts during operation in screen printing mode, and halting of said one or more mobile members during operation in digital mode; and
control of the printing heads during operation in digital mode.

4. A station for applying one or more substances according to claim 1, wherein said assembly for digital application of one or more substances comprises one or more heads for ink jet type printing.

5. A station for applying one or more substances according to claim 4, wherein said one or more heads for ink jet type printing are supplied with the same substance.

6. A station for applying one or more substances according to claim 1, wherein said assembly for digital application of one or more substances comprises a plurality of heads for ink jet type printing.

7. A station for applying one or more substances according to claim 6, wherein at least two of said heads for ink jet type printing are supplied with substances differing from one another.

8. A machine for applying substances to a substrate, of the type comprising a plurality of application stations arranged along a common production line, at least one unit for general control of said machine and means to transfer said substrate from one of said stations to another subsequent of said stations, characterised in that it comprises at least one station for applying one or more substances according to claim 1.

9. A machine according to claim 8, wherein at least one of said stations is set for digital application of said one or more substances and comprises at least one printing bridge which is movable in a direction perpendicular to the progress direction of said substrate.

10. A machine according to claim 8, wherein at least one of said stations is set for digital application of said one or more substances and comprises at least one fixed printing bridge which extends perpendicularly in relation to the progress direction of said substrate.

11. A machine according to claim 8, wherein at least one of said stations is set for digital application of said one or more substances and comprises one or more heads for ink jet type printing.

12. A machine according to claim 11, wherein said one or more heads for ink jet type printing are supplied with the same substance.

13. A machine according to claim 8, wherein at least one of said stations is set for digital application of said one or more substances and comprises a plurality of heads for ink jet type printing.

14. A machine according to claim 13, wherein at least two of said heads for ink jet type printing are supplied with substances differing from one another.

15. A machine according to claim 8, wherein at least one drying station of said substances is provided interposed between at least two of said stations for applying said one or mores substance to said substrate.

16. A machine according to claim 8, wherein said means for transferring said substrate from one of said stations to another subsequent of said stations comprises at least one conveyor belt controlled by said general control unit.

17. A machine according to claim 8, wherein said means for transferring said substrate from one of said stations to another subsequent of said stations comprises gripping units associated with each of said stations and controlled by said general control unit.

18. A machine according to claim 8, wherein at least one of said stations is set for digital application of said one or more substances and at least another of said stations is set for screen printing application of said one or more substances.

19. A method for applying substances to a substrate, wherein said substances are applied to said substrate in a plurality of stations arranged along a common production line, characterised in that each of said stations is set for the application of one or more of said substances with the screen printing technique or with the digital technique.

20. A method according to claim 19, wherein one or more of said substances are applied by means of one or more heads for ink jet type printing.

21. A method according to claim 20, wherein one or more of said heads for ink jet type printing are supplied with the same substance.

22. A method according to claim 19, wherein one or more of said substances are applied by means of a plurality of heads for ink jet type printing.

23. A method according to claim 22, wherein at least two of said heads for ink jet type printing are supplied with different substances from one another.

24. A method according to claim 19, wherein said substrate is composed of a continuous sheet.

25. A method according to claim 19, wherein said substrate is composed of separate sheets.

26. A method according to claim 19, wherein at least one of said substances is applied to said substrate with the screen printing technique, and at least another of said substances is applied with the digital technique.
